(19) United States
(12) Patent Application Publication
(10) Pub. No.: US 2002/0137635 A1
(43) Pub. Date: Sep. 26, 2002

(54) Fluids for use in oilfield development comprising deacetylated xanthan gum and at least one compound increasing the ionic strength of the medium

(76) Inventor: Bruno Langlois, Sainte Genevieve Des Bois (FR)

Correspondence Address: RHODIA INC., CN-7500, 259 Prospect Plains Road, CRANBURY, NJ, 08512, US

(21) Appl. No.: 10/082,555

(22) Filed: Oct. 22, 2001

Related U.S. Application Data
(63) Continuation of application No. 09/462,995, filed on Jan. 14, 2000.

(30) Foreign Application Priority Data
Jul. 17, 1997 (FR) 97/09087

(51) Int. Cl. C09K 7/06

(52) U.S. Cl. 507/110

(57) ABSTRACT

The invention concerns guar-free fluids capable of being used in oil mining and containing deacetylated xanthan gum in the form of a polypentamer, combined with at least one compound increasing the medium ionic strength. The invention also concerns the use, as filtrate reducer with improved properties, of deacetylated xanthan gum in the form of a polypentamer, combined with a compound increasing the medium ionic strength and a standard filtrate reducer.

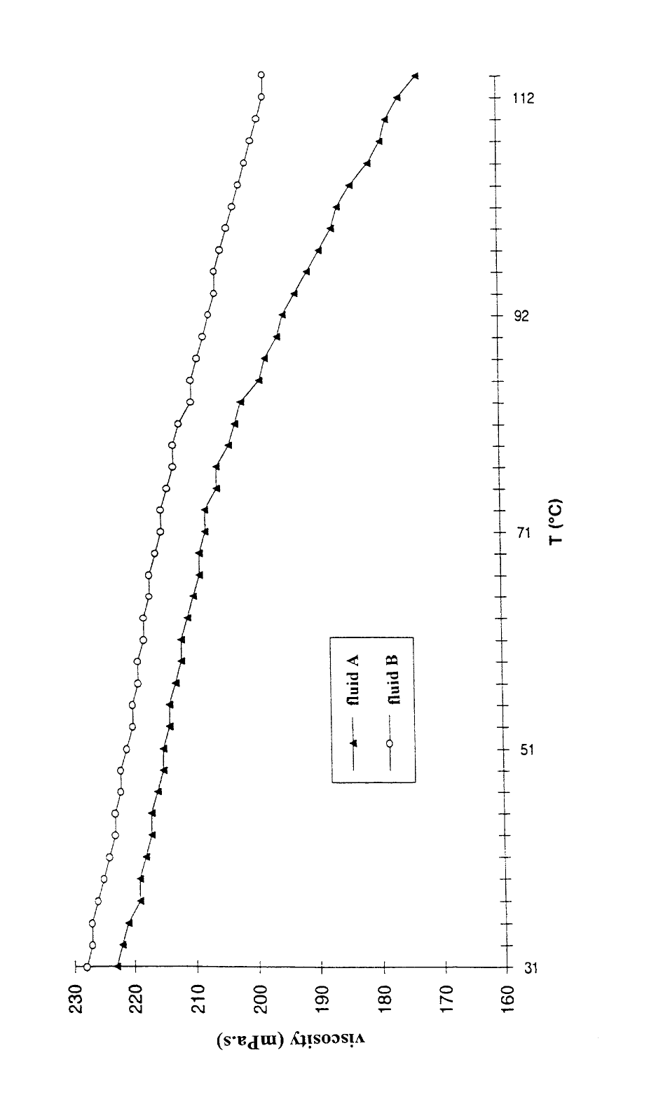

The present invention relates to fluids with applications in the field of oil extraction, both for well development operations such as drilling operations, work-over operations or completion operations and for oilfield production proper.

More particularly, the invention relates to oil well drilling fluids used in the presence of water and muds.

Drilling operations consist of forming a hole using a drill bit, generally of tungsten carbide fixed to hollow pipes screwed end to end. A mud comprising additives in aqueous solution is usually injected into the pipe string. This mud then rises in the bore hole externally of the string and rock elements detached during the drilling operation. At the same time the mud, charged with rock, establishes a counter-pressure which consolidates the hole. The mud is then extracted from the bore hole and the rock it contains is removed before being injected again into the hollow drill pipe.

Under such operating conditions, it is essential that the additives added to the mud endow it with a particular theological behaviour. When it is subjected to very high shear stresses and high temperatures, as is the case around the drill, the fluid must have a sufficiently low viscosity to enable it to be evacuated from the hollow pipes. In contrast, the same fluid, charged with rock, must have a high viscosity in order to keep the cuttings entrained during drilling in suspension.

High molecular weight polysaccharides such as xanthan gum are used as additives for drilling fluid or mud in order to endow that fluid with the particular rheological behaviour described above; it is known as a shear thinner.

However, while xanthan gum has undeniable advantages for this type of application, it is nevertheless limited as the theological properties of the drilling fluid degrade over time, even more rapidly when the temperature to which it is subjected it close to or above 120° C. In oil well drilling operations, however, such temperatures are often reached. The mud is heated considerably by the motion of the drill bit. Further, the depth of the field and its geographical situation also have substantial consequences on the temperature to which the fluid is subjected. Thus temperatures of this order of magnitude are easily reached at the bottom of wells since the depths reached during drilling operations are of the order of a kilometer, sometimes more. Further, wells exist where the temperature of the earth's crust itself is higher than normal (hot wells), which further accentuates the effect of the increase in sub-soil temperature with depth.

Under normal conditions, the effect caused by such temperatures is not always unacceptable, especially when starting to use an additive, as the period during which the fluid is subjected to such high temperatures is limited. However, it is necessary to know that it is not rare to have to stop drilling operations to add pipes or to replace one of the tools, for example the drill bit. In such a case, the drilling fluid remains under high temperature conditions for a relatively long period.

When the fluid is subjected to such temperatures, its viscosity degrades considerably and often it can no longer carry out its role of suspending the cuttings removed during the drilling operation. This can thus be one of the causes of blocking the well by deposition of the rock at the bottom thereof.

U.S. Pat. No. 5,591,699 describes a combination of non acetylated xanthan gum with guar as a cuttings suspension agent in a well. That patent demonstrates a synergy between the two constituents, meaning that the quantities of each of these elements are low. However, the combination in question can only retain its viscosity properties and its ability to keep cuttings in suspension when the temperature is over 100° C., which is usual in operating oil wells, inter alia because of the high heat sensitivity of the guar.

U.S. Pat. No. 3,729,460 describes a thickening composition obtained by treating xanthan gum with a base. The resulting product, with an improved thermal resistance compared with the initial xanthan gum, can be used for enhanced oil recovery. However, as the text of that patent indicates, the polymer obtained by the treatment with caustic soda is substantially modified with respect to the structure of the initial xanthan gum and most probably causes hydrolysis. As also clearly indicated in that patent, partial depolymerisation occurs along with hydrolysis of the xanthan gum.

U.S. Pat. No. 3,319,715 indicates the use of xanthan gum combined with a magnesium dihydroxide as a fluid loss control agent, which is stable at temperatures of the order of 120° C. However, the xanthan gum in question is highly specific as it is constituted by an acetylated polymer containing 8 motifs in the following mannose/glucose/glucuronate proportions: 3/3/2 respectively.

The present invention proposes a solution to the problem of the stability of the theological properties of a fluid at high temperatures.

Thus in a first aspect the invention provides guar-free fluids for use in petroleum comprising, in combination, deacetylated xanthan gum in the form of a polypentamer, and at least one compound which increases the ionic strength of the medium.

It has surprisingly been discovered that deacetylated xanthan gum when used in a composition for such fluids, combined with at least one of the compounds cited above, more particularly a salt of a mineral or possibly an organic acid, can stabilise the rheological properties of the system at temperatures which can be as high as 140° C.

It should be noted that the skilled person would not be expected to have such results at his disposal.

Firstly, it should be remembered that standard xanthan gum, i.e., that containing acetyl and pyruvyl motifs, has a transition temperature of close to 90° C. in a concentration of 0.3% in distilled water. The term “transition temperature” means a transconformational temperature, i.e., the temperature at which the polymer in solution passes from an ordered conformation to a disordered conformation. This conformational change is perfectly reversible and does not affect the molecular weight of the gum. However, if the fluid comprising the xanthan gum is used at a temperature above the transition temperature of that polymer, the rheological properties of the fluid are substantially modified, and the viscosity drops considerably, which is undesirable for the intended application. Thus in practice, the skilled person will seek as high a transition temperature as possible to overcome this problem.

If a combination of standard xanthan gum and salts such as sodium chloride is used as the constituent elements of the fluid, the transition temperature of the xanthan gum can be increased to values as high as 140° C. Unfortunately, the beneficial aspect of that combination is limited by the appearance of supplemental phenomena linked with thermal degradation of the xanthan gum. When the fluid is kept at high temperatures, depolymerisation phenomena occur which reduce the mass of the polymer and modify the rheological properties of the fluid.

One way of compensating for this problem is to regularly introduce xanthan gum. However, when the service temperature of the fluid exceeds the transition temperature of the polymer, causing a loss of rheological properties in the fluid, the degradation phenomena are amplified, rendering use very difficult or almost impossible, even on adding xanthan gum.

With deacetylated xanthan gum, when it is used alone in a concentration of 0.3% in distilled water, the transition temperature is close to 60° C. Thus such a transition temperature has a disadvantage with respect to standard xanthan gum, since undesirable and substantial drops in viscosity occur at a temperature which is lower than that for standard xanthan gum, reducing the range of use of the gum.

As can be seen, these results would not lead the skilled person to select deacetylated xanthan gum with the aim of preparing drilling fluids which were stable at high temperatures.

It has been noticed that, completely unexpectedly, a synergistic effect exists between deacetylated xanthan gum and salts. Under these conditions, at the same concentration of 0.3% and with the ionic strength imposed by the salt, the transition temperature is identical to that of standard xanthan gum and not lower as is the case with distilled water. This effect is still greater since deacetylated xanthan gum also has a much higher chemical stability than standard xanthan gum in its ordered form. As a result, this deacetylated xanthan gum is perfectly stable in the presence of salts at temperatures where standard xanthan gum will degrade.

Thus the combination of deacetylated xanthan gum and salts of the present invention can produce a drilling fluid which can be used at high temperatures, of the order of 140° C., without the need to compensate for a loss of rheological properties by adding large quantities of xanthan gum, as was the case when using standard xanthan gum.

Further, it has been shown that deacetylated xanthan gum, in contrast to standard xanthan gum, develops more viscosity in its disordered form in the presence of a salt, which enables the skilled person to limit the technical problems encountered in the field if the service conditions for the fluid include temperatures over the transition temperature.

Finally, it has been noted that, unexpectedly, deacetylated xanthan gum combined with at least one compound increasing the ionic strength of the medium has improved fluid loss control characteristics. It should be remembered that the role of fluid loss control agents is to prevent the loss of fluid in the well by infiltration into the rock.

We have also, completely surprisingly, discovered that deacetylated xanthan gum combined with a salt and a conventional fluid loss control agent considerably improves the properties of this combination. Firstly, a substantial synergistic effect exists between xanthan gum and the fluid loss control agent. However, the most characteristic synergistic effect is demonstrated when the mud is tested at high temperatures. In contrast to conventional fluid loss control agents where the properties are substantially degraded after hot ageing, mud comprising deacetylated xanthan gum, combined with a salt and with a further, conventional, fluid loss control agent, has still further improved fluid loss control properties compared with muds which have not undergone such a heat treatment.

Further advantages and characteristics will become clear from the following description and examples.

The figure shows the variation in viscosity as a function of temperature of a mud of the invention and a comparative mud comprising standard xanthan gum.

Before describing the fluid of the invention, it should be made clear that the latter is particularly suitable for use as a drilling fluid.

However, its rheological properties, filterability, and compatibility with a number of components also render it suitable for subsequent applications to drilling per se and/or to applications linked with oilfield production.

Thus by dint of adapting these characteristics such as viscosity, the fluid can be used during work-over operations. It is also possible to use the fluid, again after adjusting its rheological characteristics, for enhanced oil recovery.

For simplification, the remainder of the text will only mention the application of the fluid of the invention to drilling operations, it being understood that the use of such a fluid is not limited to such an application alone.

As mentioned above, the fluid of the invention comprises deacetylated xanthan gum.

Within the context of the present invention, a deacetylated xanthan gum in the form of a polypentamer is used.

It should be remembered that standard xanthan gum is an anionic heteropolysaccharide. The repeat units of the polymer are a pentamer composed of five sugars, namely two glucose motifs for the repeat units of the main chain which forms the backbone of the polysaccharide, two mannose motifs, and a glucuronic motif for the side chains. In general, this basic structure is acetylated and pyruvylated in degrees which, in nature, vary. The acetyl groups are encountered on the first mannose or internal mannose; in other words that which is linked to the main chain by a glucose, and on the last mannose or external mannose of the side chain. A pyruvyl group can also be found in place of the acetyl group on the last mannose.

The term “deacetylated xanthan gum” as used in the present invention means a xanthan gum from which at least a portion of the acetyl groups has been removed. This term also encompasses a xanthan gum with a lower number of acetyl groups than that obtained for standard xanthan gum because of the particular genetic characteristics introduced into the micro-organism; characteristics which result in direct synthesis of a polysaccharide with a lower number of acetyl groups.

In a particular advantageous embodiment of the present invention, the percentage acetylation of the polysaccharide used in the fluid composition is less than 3%; more particularly, it is in the range 0 to 3%, and preferably in the range 0 to 2%.

In a particularly advantageous and preferred embodiment of the present invention, a polymer is used which contains no more or no acetyl motifs whereby said xanthan gum is respectively obtained by a chemical or enzymatic route or from genetic modification of the strain.

Regarding the pyruvyl motif, it should be noted that this may or may not be present in the polymer structure. In a particular embodiment of the invention, a deacetylated xanthan gum as defined above is used, which still contains a pyruvylated motif.

It is understood that the polysaccharide can be in the form of a mixture or in a single form.

Preferably, the polysaccharide (or xanthan gum) is in the form of a single polymer and not a mixture of several forms.

The deacetylated xanthan gum is a polysaccharide which is known to the skilled person which can be obtained by a variety of routes, consisting either of modifying the standard xanthan gum by a chemical or enzymatic route, or by genetically modifying the strain producing the polysaccharide.

Firstly it should be remembered that xanthan gum is obtained by fermentation of micro-organisms from the genus Xanthomonas, more particularly by fermenting micro-organisms selected from the following species: Xanthomonas Campestris, Xanthomonas Carotae, Xanthomonas Begoniae, Xanthomonas Hederae, Xanthomonas Incanae, Xanthomonas Malvacearum, Xanthomonas Papavericola, Xanthomonas Phaseoli, Xanthomonas Pisi, Xanthomonas Vasculorum, Xanthomonas Vesicatoria, Xanthomonas Vitians, Xanthomonas Pelargonii. More particularly, a Xanthomonas Campestris micro-organism is used.

Briefly, a xanthan gum is synthesised by fermentation in an aerobic medium by inoculating the micro-organism into a culture medium comprising, inter alia, carbohydrate compounds such as glucose or soluble starch, used alone or in a mixture. These compounds can be in a refined or unrefined form.

Fermentation is generally carried out at a temperature close to ambient temperature although higher temperatures are not excluded.

The polysaccharide obtained is then separated from the fermentation medium by centrifuging or by filtering. A purification step can then optionally be carried out. In general, if it is carried out, purification is effected by precipitation from a suitable compound such as methanol, ethanol or acetone, or the like.

The polysaccharide obtained can be deacetylated using chemical, enzymatic or genetic routes.

In a first variation the xanthan gum produced is chemically modified by eliminating the acetyl group or the acetyl groups it contains.

This operation is generally carried out by bringing the polysaccharide into contact with a base. The treated polysaccharide can be unrefined or purified.

Bases which can be used include sodium hydroxide and potassium hydroxide, optionally in the presence of potassium chloride or ammonia.

The pH of the aqueous phase is in the range 9 to 12.

The operation can take place in an inert atmosphere such as nitrogen, or in air. More particularly, the reaction is carried out in a stream of gas.

Deacetylation can take place at ambient temperature or at a temperature above ambient temperature in order to accelerate the reaction. As an example, temperatures of the order of 100° C. to 150° C. may be perfectly suitable.

The reaction is carried out over a period in the range from a few minutes to 2 hours or more.

It should be noted that the duration of the reaction depends on the pH and on the temperature at which the treatment is carried out.

The reaction is monitored by measuring the viscosity of the mash, so as to prevent the xanthan gum from depolymerising. Thus as soon as the viscosity falls, the reaction is stopped.

Once the reaction is over, the reaction medium is cooled if necessary then an acid such as hydrochloric acid is added so as to obtain a pH of the aqueous solution comprising the polysaccharide in the range 4 to 9, preferably close to 7.

The resulting polysaccharide can be recovered either by precipitation from a suitable compound such as alcohols, imines, amines, compounds containing quaternary ammonium or polyvalent cations. It is also possible, and advantageous, to directly dry the polysaccharide obtained.

In a further variation, the xanthan gum can be enzymatically modified.

A final possible variation consists of using a micro-organism which has been genetically modified to produce a non acetylated xanthan gum. Reference should be made in this regard to International patent application WO 92/19753 which describes various methods of treating a strain with the aim of obtaining modified xanthan gums.

More particularly, the xanthan gum used as a constituent in the fluids of the invention has been obtained using a genetically modified strain.

In a preferred embodiment of the invention, the xanthan gum obtained by fermenting a strain corresponding to references X 1006 and X 1910 in International patent application WO 92/19753 cited above are used under the conditions described therein. Preferably, a deacetylated xanthan gum obtained by fermenting the X 1910 strain described in that patent application is used.

More particularly, the quantity of xanthan gum used in the fluid composition of the invention is in the range 0.01% to 2% with respect to the total fluid weight.

It is noted that very good oil well development results can be obtained using smaller quantities of xanthan gum than those used with a standard xanthan gum. In the presence of salts, deacetylated xanthan gum has a higher viscosity than standard xanthan gum when the fluid temperature is increased. At the same concentration, then, the fluid viscosity at the bottom of a well is higher in the case of the present invention.

The deacetylated xanthan gum is used in combination with at least one compound which increases the ionic strength of the medium. Suitable compounds which can be cited include salts of mineral acids and possibly organic acids.

It is noted that the above compounds can play a supplemental role in the drilling fluid, as a weighting material and as an agent encouraging the precipitation of particular ions or as an agent limiting swelling of certain rocks. This will be described in more detail below.

Salts which are soluble or at least partially soluble in the medium are preferably used.

Examples of mineral acid salts which can be cited are alkali or alkaline-earth metal halides such as sodium chloride, potassium chloride, caesium chloride, magnesium chloride, sodium bromide or potassium bromide. Sulphates, carbonates, bicarbonates, silicates, or phosphates of alkali or alkaline-earth metals can also be used, alone or as a mixture. Examples of organic acids which can be mentioned are alkali or alkaline-earth metal formates and alkali or alkaline-earth metal acetates.

In a first advantageous variation of the invention, at least one salt selected from halides can be used, more particularly alkali or alkaline-earth metal chlorides.

More particularly, salts such as sodium chloride or potassium chloride are used.

In a second variation of the present invention, at least one salt selected from silicates is used, optionally combined with the salts cited in the first variation. Sodium silicates are preferably used, optionally in combination. More particularly, silicates with a Na₂O/SiO₂ molar ratio of close to 1/2 are used.

Fluids comprising silicates have the advantage of inhibiting swelling of the clays present in the formation, which limits damage to the well. Silicates also have an effect on the fluid viscosity and can contribute to improving the fluid loss effect.

More particularly, the amount of compound which increases the ionic strength of the medium is in the range 5000 to 110000 parts per million.

Even though it has been noted that deacetylated xanthan gum would have a certain ability as a fluid loss control agent, the scope of the present invention also encompasses the addition of such a type of compound.

In contrast, and herein lies one of the completely surprising characteristics of the present invention, it is particularly advantageous to combine deacetylated xanthan gum with a standard fluid loss control agent. The combination of these two compounds has a synergistic effect which is more marked when the mud comprising these two compounds has undergone hot ageing. In other words, the properties of the muds of the invention improve during use, and this is indeed a remarkable and completely unexpected result.

Thus in a further aspect, the invention is constituted by a fluid loss control agent consisting of a combination of a deacetylated xanthan gum, at least one compound increasing the ionic strength of the medium and at least one conventional fluid loss control agent.

Any of the foregoing regarding the nature of the compounds increasing the ionic strength of the medium remains valid and will not be repeated in this part of the description.

It should be remembered that fluid loss control agents are generally compounds with a relatively low molecular weight. As a result, the contribution of these compounds to the viscosity of the formulation is almost non existent when used in small amounts.

Non limiting examples of fluid loss control agents are cellulose compounds, polyacrylamides, high molecular weight polyacrylates, succinoglycanes, native starch or its derivatives, and charcoal. Cellulose compounds which can be mentioned are non modified or chemically modified celluloses such as carboxymethylcelluloses, hydroxyethylcelluloses, carboxyethylhydroxyethylcelluloses. Modified celluloses with a low or high degree of substitution can be used. In a particular embodiment, no guar is used.

The quantity of fluid loss control agent depends greatly of the nature of the traversed rock. Further. the quantities must not exceed a threshold which renders them deleterious to the formulation. In general, these compounds have a newtonian rather than a shear thinning rheological profile. As an indication, the quantity of fluid loss control agent is normally in the range 0 to 1% with respect to the total fluid weight.

In the present case, deacetylated xanthan gum can be used as a fluid loss control agent in the same quantities.

Drilling fluids can also comprise thinners or dispersing agents. Thus drilling fluids can include polyphosphates, tannins, lignosulphonates, lignin derivatives, peats and lignites, polyacrylates, polynaphthalene sulphonates, used alone or as a mixture.

The quantity of thinner or dispersing agent can vary. As an indication, it is in the range 0 to 1% with respect to the total fluid weight.

The drilling fluid of the invention can also comprise an oxygen scavenger. This type of additive traps oxygen present in drilling mud which can cause certain additives to degrade.

Examples of products of this type include hydroxylamines, hydrazine, sulphites, bisulphites, hydrosulphites and borohydrides.

In a particular embodiment. hydrazine is used as an oxygen scavenger as it does not cause the formation of insoluble precipitates increasing the possibility of blockages in the well. Hydrazine can be in an anhydrous or hydrated form, in the form of salts, for example chlorides or sulphates, or in the form of the carbohydrazide.

In general, the amount of this additive is in the range 0 to 0.25%.

The drilling fluid of the invention can also comprise at least one weighting material and/or at least one mineral colloid.

Weighting materials contribute to maintaining a sufficient hydrostatic pressure in the well and to maintaining the rocks entrained during the drilling operation in suspension. Such compounds are conventionally selected from the soluble salts cited above and slightly or very slightly soluble salts. Non limiting examples of slightly soluble salts include alkaline-earth metal sulphates, silicates and carbonates such as barium sulphate or calcium carbonate.

It is also possible to use alkaline-earth metal or zinc bromides such as potassium bromide or zinc bromide. It is also possible to use iron oxides or sulphides or sub arsenates. It is also possible to use strontium sulphate and in some cases for high densities, galena (lead sulphide).

Mineral colloids, which are compounds which are substantially insoluble under the conditions of use of the fluids of the invention, are agents which modify the rheology of the medium and which can maintain the cuttings in suspension in the fluid. Attapulgite, barite, bentonite, used alone or as a mixture, are examples of the most frequently used compounds. It should be noted that it a fluid comprising a mineral colloid is used, the latter is preferably attapulgite.

The amounts of weighting materials and mineral colloids depend on a number of factors which are not entirely technical. While these quantities are clearly fixed depending on the nature of the rocks traversed, the cost of using these additives is also taken into account (presence on site or otherwise, cost, etc . . . ).

Often, and always with the aim of minimising the costs incurred, the drilling fluid is prepared using water present on the drilling site. Thus it is not unusual to be in the presence of formation water (in contrast to composition water, i.e., water prepared with a particular aim) charged with salts, such as sea water, brine or hard water. In this case, the amount of salts used in the water varies depending on its origin.

It may, however, be the case that the water which is available is water which is not or is only slightly charged. In this case, it may be necessary to add salts such as chlorides.

It is also possible to add, if necessary, mineral salts to encourage the precipitation of certain ions, if present, in particular divalent ions. Thus, for example, adding sodium carbonate to precipitate calcium, or sodium bicarbonate to precipitate lime can be added, in particular when drilling out cement. It is also possible to cite gypsum or calcium chloride addition to limit the swelling of clays, addition of calcium hydroxide, or dead lime, to remove bicarbonate from mud contaminated with carbon dioxide.

The quantity of salts is again dependent on the rocks traversed and the water available at the production site and the operations can be carried out in the presence of fluids which are saturated with salts.

Clearly, the drilling fluid of the present invention can comprise the usual additives from the high molecular weight polysaccharide class such as succinoglycane, Wellan, Gellan, used as viscosifying agents.

Other additives which are conventional for applications concerning oil well production can be used in the fluid composition. Examples which can be mentioned are free radical transfer agents, such as lower alcohols, thioureas or hydroquinone; biocides, chelating agents, surfactants, anti-foaming agents, and anticorrosion agents.

As indicated above, the fluid of the present invention is particularly suitable for use as a drilling fluid.

To this end, all types of drilling are suitable, whether vertical, horizontal or oblique, such as those carried out from off-shore platforms.

It should be noted that because of these properties (in particular compatibility with many compounds), the fluid of the invention does not contaminate cement during work-over operations. These operations consist of introducing a metal casing into the well to consolidate it once well drilling is complete, then pouring cement between the casing and the well wall.

Further, by adapting the characteristics of the fluid (rheology, composition), the fluid of the invention can be used as a spacer fluid, for example.

The fluid of the invention, after adapting its composition and its theological properties, can be used during oil well production, in particular during enhanced oil recovery. Thus it is possible to use it as a stimulation fluid which represents one of the methods developed for improving the production yield of an oil well. This fluid is introduced at another location in the field and because of its high viscosity can entrain an additional quantity of oil, thus increasing the extraction yield.

Non limiting examples of the invention will now be described.

### EXAMPLE 1

This example demonstrates the relative loss (as a percentage) in viscosity of a standard xanthan gum (comparative) and a deacetylated xanthan gum (of the invention).

The measurements were made using xanthan gum concentrations of 0.3% in ASTM sea water between 20° C. and 120° C. In this case, the xanthan gum is in the ordered conformation.

It should be noted that the deacetylated xanthan gum was obtained by fermenting the X 1910 strain described in International patent WO 92/19753.

Strain X 1910 was fermented under conventional conditions for fermenting the Xanthomonas Campestris strain. More particularly, the carbon source was glucose. Fermentation took place in air, with stirring, at a temperature in the range 27° C. to 30° C., at a pH in the range 6.5 to 7.5.

The polysaccharide was recovered conventionally.

The results show that deacetylated xanthan gum combined with a salt retained 15% to 20% more viscosity in a range of 100° C. to 120° C. than the standard xanthan gum.

It should also be noted that from 40° C., the standard xanthan gum had already lost 5% of viscosity with respect to the deacetylated xanthan gum.

The use of deacetylated xanthan gum in accordance with the present invention thus improved suspension of cuttings at the bottom of a well and as a result considerably improved cleaning of the hole.

### EXAMPLE 2

The aim of this example was to measure the evolution of the rheology of saline solutions comprising standard xanthan gum (comparative) and then deacetylated xanthan gum as a function of temperature.

The tested solutions were solutions of xanthan gum (0.3%) in ASTM sea water before and after working for 16 hours at 120° C.

Ageing was carried out in stainless steel cells provided with a Teflon liner. The cells were pressurised with nitrogen.

The rheology measurements were carried out in accordance with API standards (Bulletin 13D) using a Fann 35. The temperature of the measurements was 22±1° C., by direct reading of the deviation of a tension wire. The rotation rates were 600, 300, 200 and 100 rpm.

The results, measured using a Fann 35 (Baroid), are shown in the following table:

| Sample reference | 600 rpm | 300 rpm | 200 rpm | 100 rpm |
|---|---|---|---|---|
| | BEFORE WORKING AT 120° | | | |
| Rhodopol 23P ® (comparative) | 90 | 70 | 61 | 51 |
| Deacetylated xanthan gum | 90 | 73 | 62 | 50 |
| (invention) | | | | |
| | AFTER WORKING AT 120° | | | |
| Rhodopol 23P ® (comparative) | 36 | 26 | 24 | 18 |
| Deacetylated xanthan gum | 88 | 72 | 59 | 47 |
| (invention) | | | | |

Unexpectedly, it can be seen that in its ordered form, the deacetylated xanthan gum was perfectly stable while the standard xanthan gum degraded, modifying the theological behaviour of the solution.

### EXAMPLE 3

The present example demonstrates the evolution of the viscosity profile between 30-115° C. of muds comprising bentonite, sea water and comprising a mixture of xanthan gum and Drispac Regular polyanionic cellulose as a rheology modifier and a fluid loss control agent, weighted with barite (density 1.4).

The mud composition was as follows:

| | | Fluid A | Fluid B |
|---|---|---|---|
| COMPOUND | Units | (comp) | (invention) |
| Bentonite slurry (5%) | g | 157.5 | 157.5 |
| ASTM sea water | g | 140.3 | 140.3 |
| Polyanionic cellulose (Drispac | g | 0.5 | 0.5 |
| Regular ®) | | | |
| Standard xanthan gum (Rhodopol | g | 2.3 | — |
| 23P ®) | | | |
| Deacetylated xanthan gum (from | g | — | 2.3 |
| Example 1) | | | |
| NaHCO₃ | g | 0.65 | 0.65 |
| Na₂CO₃ | g | 0.22 | 0.22 |
| Dispersing agent: Polyacrylate 3500 | g | 0.75 | 0.75 |
| Barite | g | 197.2 | 197.2 |

The bentonite was pre-hydrated for 16 hours (5% slurry in water) before complete preparation of the mud. The barite conformed to API specifications.

The results are shown in the Figure.

The Figure shows that despite the fact that the transition temperature was the same for the two polymers (standard and deacetylated xanthan gum), about 118° C., the mud containing the deacetylated xanthan gum of the invention had a much smaller variation in viscosity with temperature.

Further, the table below shows that the variation in viscosity with temperature was much smaller in the case of the present invention than in the case of muds formulated with standard xanthan gum:

| Variation in viscosity between | | |
|---|---|---|
| 30° C. and 115° C. | Fluid A | Fluid B |
| Δη/η (%) | −24% | −15% |

The initial viscosities of the two fluids, namely 229 mPa.s at 100 s⁻¹ for fluid A and 234 mPa.s for fluid B, are considered to be identical.

At the well bottom where the temperature is at its highest, a loss of close to 25% of the initial pumping viscosity was noted with a fluid based on a standard xanthan gum, while this loss was limited to 15% for the fluid formulated with deacetylated xanthan gum. This difference constitutes a substantial advantage when using the fluid in particular as regards cleaning the well and the speed of the drilling operation.

### EXAMPLE 4

This example measured the relative viscosities of the fluids described in the preceding examples.

Thus fluids A and B were kept at 130° C. for one hour at a shear rate of 100 s⁻¹. The temperature was then reduced from 130° C. to 20° C. at a rate of 2° C./min and the difference in the relative viscosity between the fluid initially heated to the temperature under consideration, namely 30° C., and the viscosity of the fluid after 1 hour at 130° C., was measured at this same temperature of 30° C.

In their disordered form, the two xanthan gums degraded resulting in a loss in the initial viscosity properties.

The table below indicates the relative loss of viscosity after 1 hour at 130° C.

| Variation in viscosity | | |
|---|---|---|
| after cycle | Fluid A | Fluid B |
| Δη/η (%) | 37% | 22% |

The variations were calculated from apparent viscosities at 100 s at 30° C.

However, the table also clearly shows that the deacetylated gum combined with a salt degraded less than the standard xanthan gum under the same conditions.

Thus fluid B of the invention could retain more viscosity with the result that less xanthan gum had to be added to keep the properties of the drilling fluid constant.

### EXAMPLE 5

The present example demonstrates the rheological profile between 20° C. and 140° C. of a mud salted with KCl comprising a mixture of xanthan gum and polyanionic cellulose as a rheology modifier and fluid loss control agent, glycol and weighted with barite.

The mud composition was as follows:

| COMPOUND | Units | Fluid C | Fluid D |
|---|---|---|---|
| Fresh water | litre | 1 | 1 |
| KCl | g | 150 | 150 |
| Polyanionic cellulose (Drispac | g | 1.4 | 1.4 |
| Regular ®) | | | |
| Standard xanthan gum (Rhodopol 23P ®) | g | 6.4 | — |
| Deacetylated xanthan gum (from | g | — | 6.4 |
| Example 1) | | | |
| NaHCO₃ | g | 0.65 | 0.65 |
| Glycol | ml | 40 | 40 |
| Barite | g | 560 | 560 |

Polyanionic cellulose is sold by Drispac; the barite conformed to API standards.

The polymer transition temperature was shown to be the same for the two polymers (standard and deacetylated xanthan gum), namely 140° C.

However, the variation in viscosity of fluid D of the present invention between 30° C. and 140° C. was less, as shown in the table below:

| Variation in viscosity | Fluid C | Fluid D |
|---|---|---|
| Δη/η (%) | −21% | −10% |

Thus the drilling fluid of the invention retained twice the viscosity at the bottom of the hole where the temperature was the highest, improving the efficiency of the cleaning operation and thus increasing the rate of tool advance.

### EXAMPLE 6

The present example compares the fluid loss control properties of fluids comprising standard xanthan gum (comparative) and deacetylated xanthan gum (invention).

The measurements were firstly carried out on fluids C and D defined in the preceding example, at low temperature and at a pressure of 7 bars in accordance with API standard 131.

The muds were then heat aged at 140° C. for 16 hours using the same protocol as in Example 3.

The API filtrate volumes are shown in the table below:

| | | | |
|---|---|---|---|
| | Filtrate volume at | Filtrate volume at | Filtration cake |
| Fluid ref. | 7.5 min (ml) | 30 min (ml) | thickness (mm) |

1/ Volume of API filtrate before ageing:

| | | | |
|---|---|---|---|
| FLUID C | 4.1 | 7.9 | ≈1 |
| FLUID D | 3.5 | 7.3 | ≈1 |

2/ Volume of API filtrate after ageing:

| | | | |
|---|---|---|---|
| FLUID C | 60 | 151 | 10 |
| FLUID D | 2.1 | 4.5 | ≈1 |

The fluid formulated with standard xanthan gum was shown to be completely degraded with the heat treatment which meant that fluid loss could no longer be controlled and engendered a high risk of damaging the formation.

In contrast, the fluid formulated with deacetylated xanthan gum, which was perfectly stable in its ordered form, retained excellent fluid loss control, with the formation of a compact cake. Thus the risks of damage to and sticking of the string were substantially limited.

A synergy was also observed between polyanionic cellulose and deacetylated xanthan gum, providing better fluid loss control after preparing the fluid.

### EXAMPLE 7

The aim of this example was to demonstrate the synergistic effect on the fluid loss control properties of deacetylated xanthan gum when combined with a conventional fluid loss control agent and the superiority of a mud of the invention compared with a mud formulated with standard xanthan gum.

To this end, three muds were prepared; the first was in accordance with the invention, the second contained only the conventional fluid loss control agent.

| COMPOUND | Fluid E | | Fluid F | | Fluid G | |
|---|---|---|---|---|---|---|
| Tap water | 1 | l | 1 | l | 1 | l |
| KCl | 150 | g | 150 | g | 150 | g |
| Polyanionic cellulose (Drispac | 15.4 | g | 15.4 | g | 15.4 | g |
| Regular ®) | | | | | | |
| Standard xanthan gum (Rhodopol | — | | 6.4 | g | — | |
| 23P ®) | | | | | | |
| Deacetylated xanthan gum (from | 6.4 | g | — | | — | |
| Example 1) | | | | | | |
| Na₂CO₃ | 0.65 | g | 0.65 | g | 0.65 | g |
| Glycol | 40 | ml | 40 | ml | 40 | ml |

It was prepared as follows: the water and KCl were mixed, then the fluid loss control agent was added, then the xanthan gum with stirring, and finally the sodium carbonate and glycol were introduced.

The muds were treated in the same manner as that described in the preceding example.

| | | | |
|---|---|---|---|
| | Filtrate volume at | Filtrate volume at | Filtration cake |
| Fluid ref. | 7.5 min (ml) | 30 min (ml) | thickness (mm) |

1/ Volume of API filtrate before ageing:

| | | | |
|---|---|---|---|
| FLUID E | 5 | 8.5 | ≈1 |
| FLUID F | 4.5 | 7.5 | ≈1 |
| FLUID G | 20.5 | 25.2 | ≈1 |

2/ Volume of API filtrate after ageing:

| | | | |
|---|---|---|---|
| FLUID E | 2.3 | 5.8 | ≈1 |
| FLUID F | 9 | 16 | ≈1 |
| FLUID G | 29.5 | 35 | ≈1 |

These results show that before hot ageing, the xanthan gum of the invention combined with a fluid loss control agent, like the deacetylated xanthan gum combined with the same fluid loss control agent, produced the same good results as the fluid loss control agent alone.

In contrast, after hot rolling, it can be seen that the deacetylated xanthan gum combined with a fluid loss control agent produced remarkable and completely unexpected results.

While the properties of the muds of fluids F and G were considerably diminished, the properties of fluid E of the invention did not diminish although that result was expected. In contrast, the results were significantly improved.

### EXAMPLE 8

The aim of this example was to demonstrate that a synergistic effect existed between the deacetylated xanthan gum and another fluid loss control agent.

Muds with the following compositions were tested:

| COMPOUND | Units | Fluid H | Fluid I |
|---|---|---|---|
| Tap water | g | 350 | 350 |
| KCl | g | 54 | 54 |
| Polyanionic cellulose (Drispac | g | 1 | 1 |
| Regular ®) | | | |
| Deacetylated xanthan gum (from | g | 2 | — |
| Example 1) | | | |
| Na₂CO₃ | g | 0.25 | 0.25 |
| Glycol | ml | 15 | 15 |

The muds were tested as described in Examples 6 and 7.

The results are summarised below:

| | | | |
|---|---|---|---|
| | Filtrate volume at | Filtrate volume at | Filtration cake |
| Fluid ref. | 7.5 min (ml) | 30 min (ml) | thickness (mm) |

1/ Volume of API filtrate before ageing:

| | | | |
|---|---|---|---|
| FLUID H | 12 | 16.5 | ≦1 |
| FLUID I | 140 | 170 | ≦1 |

2/ Volume of API filtrate after ageing:

| | | | |
|---|---|---|---|
| FLUID H | 6 | 10.6 | ≦1 |
| FLUID I | Non measurable | Not measurable | Not measurable |

It can be seen that, before hot ageing, fluid H of the invention had better fluid loss control properties than fluid 1.

Further, the fluid loss control properties of fluid H were improved after heat treatment.

In contrast, those of fluid I were completely degraded and no fluid loss control measurement was possible.

1. A guar-free fluid for use in oil production, comprising a deacetylated xanthan gum in the form of a polypentamer, combined with at least one compound which increases the ionic strength of the medium.

2. A fluid according to the preceding claim, characterized in that it comprises 0.01% to 2% of deacetylated xanthan gum.

3. A fluid according to claim 1 or claim 2, characterized in that the compound increasing the ionic strength of the medium is selected from salts of mineral or organic acids such as alkali metal or alkaline-earth metal halides, sulphates, carbonates, bicarbonates, silicates, or phosphates, or alkali metal or alkaline-earth metal formates, or alkali metal or alkaline-earth metal acetates, used alone or as a mixture.

4. A fluid according to any one of the preceding claims, characterized in that the compound increasing the ionic strength of the medium is selected from halides, more particularly from alkali or alkaline-earth metal chlorides.

5. A fluid according to any one of the preceding claims, characterized in that the compound increasing the ionic strength of the medium is selected from silicates, preferably sodium silicates.

6. A fluid according to any one of the preceding claims, characterized in that the amount of compound increasing the ionic strength of the medium is in the range 5000 to 110000 parts per million.

7. A fluid according to any one of the preceding claims, characterized in that the xanthan gum contains less than 3% of acetyl groups, preferably in the range 0 to 2%.

8. A fluid according to any one of the preceding claims, characterized in that it comprises a fluid loss control agent in a quantity in the range 0 to 1% with respect to the total fluid weight.

9. A fluid according to the preceding claim, characterized in that the fluid loss control agent is selected from cellulose compounds, polyacrylamides, high molecular weight polyacrylates, succinoglycanes, native starch or its derivatives, and charcoal used alone or in combination.

10. A fluid according to any one of the preceding claims, characterized in that it comprises a thinner or dispersing agent in a quantity in the range 0 to 1% with respect to the total fluid weight.

11. A fluid according to the preceding claim, characterized in that the thinner or dispersing agent is selected from polyphosphates, tannins, lignosulphonates, lignin derivatives, peats, lignites, polyacrylates and polynaphthalene sulphonates, used alone or in combination.

12. A fluid according to any one of the preceding claims, characterized in that it comprises an oxygen scavenger in an amount in the range 0 to 0.25% with respect to the total fluid weight.

13. A fluid according to any one of the preceding claims, characterized in that a weighting compound selected from alkaline-earth metal sulphates, carbonates and silicates, alkaline-earth metal or zinc bromides or iron oxides is used.

14. A fluid according to any one of the preceding claims, characterized in that it comprises at least one mineral colloid selected from attapulgite, barite and bentonite, used alone or as a mixture.

15. A fluid according to any one of the preceding claims, characterized in that it comprises water.

16. Use of deacetylated xanthan gum in the form of a polypentamer in combination with at least one compound increasing the ionic strength of the medium, as a fluid loss control agent in oil drilling fluids.

17. Use according to the preceding claim, characterized in that the compound increasing the ionic strength of the medium is selected from alkali metal or alkaline-earth metal halides, sulphates, carbonates, bicarbonates, silicates, phosphates and formates, used alone or as a mixture.

18. Use according to claim 16 or claim 17, characterized in that the compound increasing the ionic strength of the medium is selected from alkali or alkaline-earth metal halides used alone or in combination.

19. Use according to any one of claims 16 to 18, characterized in that the deacetylated xanthan gum further comprises a fluid loss control agent.

20. Use according to the preceding claim, characterized in that the fluid loss control agent is selected from cellulose compounds, polyacrylamides, high molecular weight polyacrylates, succinoglycanes, native starch or its derivatives, and charcoal.

21. A fluid loss control agent for an oil drilling fluid, characterized in that it comprises a combination of deacetylated xanthan gum in the form of a polypentamer, at least one compound increasing the ionic strength of the medium and at least one fluid loss control agent.
